(19) United States
(12) Patent Application Publication
(10) Pub. No.: US 2012/0218477 A1
(43) Pub. Date: Aug. 30, 2012

(54) ERGONOMIC LEARNING REMOTE CONTROL

(75) Inventor: Shai SHAHAL, Tel Aviv (IL)

(73) Assignee: COMFY WARE LTD., Tel Aviv, IL (US)

(21) Appl. No.: 13/408,275

(22) Filed: Feb. 29, 2012

Related U.S. Application Data
(63) Continuation-in-part of application No. 12/247,600, filed on Oct. 8, 2008, now abandoned.
(60) Provisional application No. 60/960,638, filed on Oct. 9, 2007.

(51) Int. Cl. H04N 5/44

(52) U.S. Cl. 348/734; 348/E05.096

(57) ABSTRACT

A parentally superintended remote control unit (SCU) physically engineered and electronically adapted to the special operating requirements of toddlers and preschoolers is disclosed. The parentally superintended remote control unit comprises at least one enclosure ergonomically designed to fit the hands and digits of said toddler, at least one toddler oriented button operated graphical unit interface (GUI), offering access to at least one electronic device function. In addition the remote control unit comprises at least one computerized processing means; at least one memory means adapted to store said parentally customizable specifications; and at least one communication means adapted to enable communication between said control unit and an electronic device preferably a TV.

The SCU is provided with means to select T.V. channels and programs from a predetermined parentally approved list; and the GUI displays and commands at least one icon intuitively associated with the desired content.

### FIELD OF THE INVENTION

The present invention relates generally to the field of remote controls, more particularly to the field of remote control adapted for special needs.

### BACKGROUND OF THE INVENTION

Remote controls have become prevalent in modern homes. They control a variety of appliances from electric window shades to audio visual and computing equipment.

Moreover, the demographic of remote control users has been extended to include both the extremely young, elderly and people of varying abilities and situations. Nevertheless, design-wise, for the most part, remote controls such as disclosed in U.S. Pat. No. 5,959,751 and JP2276397 have remained targeted at the average adult user. The conventional configuration of remote controls, densely populated with a plurality of buttons, requires a high degree of coordination, a reasonable degree of cognitive competence, and good eyesight. Moreover, conventional remote controls are engineered according to health and safety regulations that assume reasonable usage by a responsible user. They often incorporate small loose parts, are susceptible to liquid damage, and are not highly insulated. Furthermore, while they can sustain minor mechanical knocks, they are not designed to withstand careless usage by users who might be unaware or otherwise unable to control repeated pressing of buttons.

Typically remote controls, especially those used for content rich applications such as cable, satellite or web based Television programs, are complex to operate, do not fit ergonomically and not at all appealing in design. Moreover, the remotes lack the robustness as well as the simplicity needed for the wide spectrum of abilities, mental, physical and developmental to be found in the average highly heterogenous human population, required for independent operation of remote controls.

Moreover, in the context of toddlers and children, almost all available appliance remote controls today do not offer parents the ability to prevent inappropriate TV channels and content viewing by their toddlers. At the same time, parental assistance is required each time the toddler requests to watch his/her favorite channel. Even for the most basic operation, such as turning the TV ON and selecting the toddler's favorite channel.

A typical TV remote control provides a vast number of control functions and key stroke combinations. Most users are simply not aware and in most cases use only very few of the remote's functionalities. These remote control devices have become too complex to operate by adults, let alone by toddlers, preschoolers, and the cognitively challenged.

The remotes of today are not particularly suited for easy operation and interaction in the virtual and web based environment.

The general increase in TV content, includes much that is inappropriate for segments of the population such as toddlers and preschoolers Toddlers and preschoolers thus increasingly risk exposure to inappropriate TV content.

Toddlers from the age of one and a half or two years old, become very curious about their environment. They become accustomed to watching TV and they study how their parents operate the TV set and remote control. Very quickly they try to demonstrate how they can operate the TV remote control. In most cases, these early attempts result in damaging the remote, often requiring the replacement of the existing remote with a new one.

For toddlers up to the age of four, it is almost impossible to operate the remote by themselves. The toddler first needs to turn on the TV, then navigate through channel zapping or specific channel number insertion. In many cases, he will have to operate a second remote, the Cable/Satellite remote control, and only then he will get the chance to navigate through the numerous channels, trying to reach his desired content.

The drawback of prior art remotes is that the remote control units are not oriented towards independent usage by toddlers, and preschoolers, the elderly, cognitively challenged people, physically challenged people or simply busy, harrassed and harried “normative” people who are unable or unwilling to be overly taxed with the complications inherent in operating conventional remote control units. Currently available TV remote controls are too complex to operate, are not ergonomically fit for purpose and are not appealing in design. Moreover, the remotes lack the robustness needed as well as the simplicity required for their independent operation.

The drawback of prior art remotes from the parents' perspective is that almost all available remote controls today do not enable parents to prevent inappropriate TV channels and content viewing by their child. At the same time, frequent parental assistance is required as the toddler requests to watch his/her favorite channel even for the most basic operation, such as turning on the TV and selecting the toddler's favorite channel.

There is thus a long felt need to overcome the drawbacks of the prior art, providing a remote control adapted for the special requirements of the entire spectrum of the population of all ages, including toddlers, elderly, cognitively or physically challenged, and normative adults.

### SUMMARY OF THE INVENTION

An object of the present invention is to provide remote control unit (SCU) physically comprising;

a. an ergonomically designed enclosure

b. at least one button-operated graphical unit interface (GUI), located on said enclosure;

c. computerized processing means;

d. memory means for storing a plurality of customizable specifications; and,

e. communication means for enabling communication between said control unit and at least one external electronic device;

wherein said unit is configured for allowing a user to control said at least one external electronic device using said GUI only according to said customizable specifications;

and wherein said GUI is configured to display at least one icon or command that is intuitively associated with specific functions of said at least one electronic device

Another object of the present invention is to provide the SCU with a computer web connection and said GUI comprises a virtual interface that electronically displays objects and icons related to specific functions of said at least one electronic device

Another object of the present invention is to provide said SCU adapted for navigation systems such that said user can navigate the web by means selected from the group consisting of global navigation, breadcrumb trails, related links, pagination (previous/next page), footer navigation, text navigation, top-level navigation, persistent navigation and primary navigation

Another object of the present invention is to provide said SCU is adapted for the visual manifestation of navigation systems selected from the group consisting of hyperlinked text, tabs, and buttons

Another object of the present invention is to provide said SCU with widgets

Another object of the present invention is to provide the SCU with means for communicating with web based social networking capabilities

Another object of the present invention is to provide the SCU adapted to provide TV or web content from TV content lists or TV guides provided on said GUI by single click or touch screen of program selections from said lists or guides.

Another object of the present invention is to provide the SCU wherein at least one of the following holds true
THe GUI has at least one said object and icon with an CIE L*a*b* characterised by an L value of between 0 and 100, an *a value of between −100 and +100 and b* value of between −100 and +100,
a resolution of between 0.1 mm to 5 mm. in the electromagnetic range of between 300 nm and 700 nm,
a contrast ratio of between 1/2 and 1/10,000 in the electromagnetic range of between 300 nm and 700 nm.

Another object of the present invention is to provide the SCU wherein at least one of the following is true;

said at least one icon is selected from a group consisting of icons, trademarks, logos, symbols, characteristic color or color mixture, shape, including 3D and 2D shaped icons, textured icons or a combination thereof

said external device is a television.

said customizable specifications includes specific television channels or programs which the user is permitted to watch,

said SCU is provided with secondary processing means conventionally used in cable and satellite boxes, further wherein said secondary memory means may be used to download frequencies and thereby select permitted channels and programs.

said secondary processing means is selected from a group consisting of smart cards, SIM cards or microchips.

Another object of the present invention is to provide the SCU physically engineered and electronically adapted for use by any persons selected from the group consisting of of elderly users, partially sighted users, hearing impaired users, disabled users, mentally impaired users, child users, users who are toddlers, teenage users, attention deficit disorder users, or adult users or any combination thereof

Another object of the present invention is to provide the SCUin which said electronic device is selected from a group including television, video players, DVD players, stereo players, audio players, computers, smartphones, or any combination thereof.

Another object of the present invention is to provide the SCU in which said customizable specifications includes volume, channel switching, forbidden content, or any combination thereof.

Another object of the present invention is to providethe SCU in which said control unit further comprises a means for recording the time lapse between multiple depressions of buttons, and more specifically of functions such as ON/OFF and volume control, and is configured to ignore the repeated actions that are typical to toddler behavior or aberrant behavior

Another object of the present invention is to provide the SCU wherein at least one of the following holds true

said interface is configured for allowing the user to update said customizable specifications as desired

said interface operates by allowing the user to flash the ROM of said unit.

said interface is configured for allowing a parent or supervisor to alter the operating parameters of at least one function of said unit.

Another object of the present invention is to provide the SCU configured for allowing an individual to change said at least one function of said unit whilst using a computer, television, wireless device, or other device connected to said unit wherein said individual is selected from the group consisting of parent, supervisor,child or toddler.

Another object of the present invention is to provide the SCU wherein at least oner of the following holds true

said external device is a television, and wherein said unit is configured for allowing a toddler to begin viewing said television, in a specific predetermined condition.

wherein at least one button of said GUI, is physically labeled with a sticker that displays objects or icons related to the desired content.

Another object of the present invention is to provide the SCU wherein said GUI, comprises a virtual interface that electronically displays objects, icons or buttons related to said desired content.

Another object of the present invention is to provide the SCU wherein at least one of the following holds true:

said GUI includes buttons that are color coded according to groups of desired content.

said GUI includes buttons that incorporate electronic displays showing objects or icons relating to the desired content.

said GUI includes touch screen that incorporates electronic displays showing objects or icons relating to the desired content.

said objects or icons represent one or more channels, options, parameters or any combination thereof.

Another object of the present invention is to provide the SCU wherein at least one of the following is true, said SCU is configured for accepting secondary processing means connected to a cable and satellite box, said secondary memory means are selected from the group consisting of Smart Cards, SIM cards, and microchips said secondary memory means can be programmed by said control unit in order to enhance communication between said unit and said cable or satellite box

said communication is wireless

a front panel of the unit can be customized to personal color preference or for commercial purposes.

the SCU is configured for sport programs

the SCU is configured for news programs.

said SCU is configured for displaying icons or logos that are visually associated with the icon or logo seen on the screen of the corresponding programme, show or TV segment.

said ergonomically designed enclosure is adapted for a user who is a toddler

said enclosure is elliptically shaped in order to enhance identification of buttons by the toddler or wherein the back of said unit is scored in order to avoid slippage when placed on varied surfaces.

Another object of the present invention is to disclose a method for using a remote control unit (SCU) physically engineered and electronically adapted to the operating requirements of, any persons selected from the group consisting of elderly users, partially sighted users, hearing impaired users, disabled users, mentally impaired users, child users, users who are toddlers, teenage users, attention deficit disorder users, or adult users or any combination thereof which can be used for selecting and viewing TV and web content comprising steps of;

a. obtaining said remote control unit (SCU) comprising;

an ergonomically designed enclosure

at least one button-operated graphical unit interface (GUI), located on said enclosure;

computerized processing means;

memory means for storing a plurality of customizable specifications; and, communication means for enabling communication between said control unit and at least one external electronic device;

wherein said unit is configured for allowing a user to control said at least one external electronic device using said GUI only according to said customizable specifications;

and wherein said GUI is configured to display at least one icon or command that is intuitively associated with specific functions of said at least one electronic device and said SCU is provided with a computer web connection further wherein said GUI comprises a virtual interface that electronically displays objects and icons related to specific functions of said at least one electronic device, further wherein said device is adapted to provide TV programs and content or web content from TV content lists or TV guides provided on said GUI by single click or touch screen of program selections from said lists or guides and

b. operating said touch screen to view said TV or programs and content or web content.

An objective of the invention is to provide a parentally superintended remote control unit (SCU) physically engineered and electronically adapted to the special operating requirements of toddlers and preschoolers. The parentally superintended remote control unit comprises at least one enclosure ergonomically designed to fit the hands and digits of the toddler, at least one toddler oriented button operated graphical unit interface (GUI), offering access to at least one electronic device function; at least one computerized processing means; at least one memory means adapted to store the parentally customizable specifications; and at least one communication means adapted to enable communication between the control unit and an electronic device preferably a TV . The SCU is provided with means to select T.V. channels and programs from a predetermined parentally approved list; and the GUI displays and commands at least one icon intuitively associated with the desired content.

Another objective of the invention is to provide the parentally superintended remote control unit (SCU) as mentioned above, wherein the intuitively associated icon is selected from a group consisting of icons, trademarks, logos, symbols, characteristic color or color mixture, shape, including 3D and 2D shaped icons, textured icons or a combination thereof.

Another objective of the invention is to provide a parentally superintended remote control unit (SCU) as described above, physically engineered and electronically adapted to the special operating requirements of toddlers and preschoolers, comprising at least one enclosure ergonomically designed to fit the hands and digits of a toddler, fashioned without sharp edges and fastened tightly together; at least one toddler oriented button operated graphical unit interface (GUI), offering access to at least one device function at least one computerized processing means; at least one memory means adapted to store the user customizable specifications; and, at least one communication means adapted to enable communication between the control unit and an electronic device preferably a TV, wherein the SCU is provided with smart cards, SIM cards or microchips conventionally used in cable and satellite boxes, further wherein the smart cards, SIM cards or microchips may be used to download frequencies and thereby select parentally permitted channels and programs.

Another objective of the invention is to provide the SCU described above in which the superintending is mediated by the owner of the SCU.

Another objective of the invention is to provide the SCU as described above in which the SCU is physically engineered and electronically adapted to the special operating requirements of elderly or disabled users.

Another objective of the invention is to provide the SCU as described above in which the electronic device is selected from a group including television, video players, DVD players, stereo players, audio players, or any combination thereof.

Another objective of the invention is to provide the SCU as described above in which said electronic device is selected from a group including television, video players, DVD players, stereo players, audio players, or any combination thereof.

Another objective of the invention is to provide the SCU as described above in which the device function refers to volume, channel switching, forbidden content, or any combination thereof.

Another object of the invention is to provide the SCU as described above in which the control unit further comprises a means for recording the time lapse between multiple depressions of buttons, and more specifically of functions such as ON/OFF and volume control, adapted to render harmless the repeated actions that are typical to toddler behavior.

Another object of the invention is to provide the SCU as described above in which one or more interfaces are adapted to facilitate the user in updating and altering said parameters in said unit.

Another object of the invention is to provide the SCU as described above in which the updating means is based on flashing the units ROM.

Another object of the invention is to provide the SCU as described above in which the interface is adapted to facilitate the parent in updating and altering parameters of said functions.

Another object of the invention is to provide the SCU as described above such that the update can be done using a computer, the television, wireless device, or other device connected to the control unit.

Another object of the invention is to provide the SCU as described above in which means are provided for the toddler to start using the electronic device preferably a television in a specific condition.

Another object of the invention is to provide the SCU as described above wherein the television is automatically turned on at desired channel and/or a desired volume, and automatically turns off at a specific hour.

Another object of the invention is to provide the SCU as described above further comprising a physical button interface, wherein each button is physically labeled with a sticker that displays objects or icons related to the desired content.

Another object of the invention is to provide the SCU as described above wherein the stickers are removable.

Another object of the invention is to provide the SCU as described above wherein said buttons are color coded to groups of desired content.

Another object of the invention is to provide the SCU as described above further comprising a physical button interface, wherein each button incorporates an electronic display that displays objects or icons related to the desired content.

Another object of the invention is to provide the SCU as described above wherein the icons represent one or more channels, options, parameters or any combination thereof.

Another object of the invention is to provide the SCU as described above wherein the control unit is elliptically shaped in order to enhance identification of buttons by the toddler.

Another object of the invention is to provide the SCU as described above wherein the back of the unit is scored in order to avoid slippage when placed on varied surfaces.

Another object of the invention is to provide the SCU as described above wherein said unit is adapted to accept smart cards conventionally used in cable and satellite boxes.

Another object of the invention is to provide the SCU as described above wherein the smartcard, SIM cards or microchips can be programmed by the control unit in order to enhance communication between the controller and the cable or satellite box.

Another object of the invention is to provide the SCU as described above in which the front panel of the unit can be replaced and customized to personal color preference or for commercial purposes.

Another object of the invention is to provide the SCU as described above wherein the unit is adapted for sport programs.

Another object of the invention is to provide the SCU as described above wherein the unit is adapted for news programs.

Another object of the present invention is to disclose an SCU adapted for navigation systems such that said user can navigate the web by means selected from the group consisting of global navigation, breadcrumb trails, related links, pagination (previous/next page), footer navigation, text navigation, top-level navigation, persistent navigation and primary navigation wherein said SCU is adapted for the visual manifestation of navigation systems selected from the group consisting of hyperlinked text, tabs, and buttons and at least one of the following holds true

said SCU is provided with widgets

further wherein the SCU has means for communicating with web based social networking capabilities and said SCU is adapted to provide TV or web content from TV content lists or TV guides provided on said GUI by single click or touch screen of program selections from said lists or guides.

Another object of the present invention is to disclose a method of viewing TV or web content from TV content lists or TV guides provided on a GUI by

obtaining the above mentioned SCU and operating it by single click or touch screen to obtain program selections from said lists or guides presented on the above mentioned GUI.

Lastly, it is an objective of the invention to disclose a method for parentally superintending TV channel choice to toddlers and preschoolers by providing a remote control unit (SCU) physically engineered and electronically adapted to the special operating requirements of toddlers and preschoolers, comprising steps of; obtaining the SCU adapting the SCU such that the choice of channels and programs accessed by the SCU is predetermined by parents further adapting the SCU such that at least one enclosure is ergonomically designed to fit the hands and digits of a toddler, fashioned without sharp edges and fastened tightly together; providing at least one toddler oriented button operated graphical unit interface (GUI), offering access to at least one electronic device function; providing at least one computerized processing means; further providing at least one memory means adapted to store the parentally customizable specifications; and, providing at least one communication means adapted to enable communication between the control unit and an electronic device preferably a TV wherein the method further comprises providing SCU with means to select T.V. channels and programs from a predetermined parentally approved list; and further wherein the method further comprises providing at least one GUI display, the display commanding at least one icon intuitively associated with the desired content.

### BRIEF DESCRIPTION OF THE INVENTION

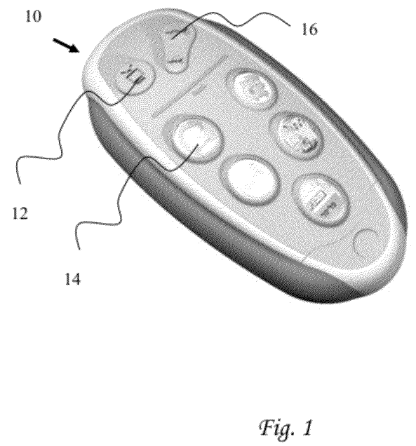

In order to better understand the invention and its implementation in practice, a plurality of embodiments will now be described, by way of non-limiting example only, with reference to the accompanying drawings, in which FIG. 1 illustrating a particular embodiment of the present invention in which a remote control is ergonomically shaped to fit the special requirements of toddlers, and sparsely populated by a limited amount of relatively large buttons adapted for easy identification and usage by toddler digits.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide uniquely designed, programmable TV remote control specially customized and adapted for the use and handling of toddlers and preschoolers

A parentally superintended control unit (PSCU) is disclosed. Hereinafter the term “parentally superintended” refers to an embodiment of the invention wherein although there is overall chaperoning or superintending by the parent of the choices available to the control unit, the toddler has freedom of choice within the parameters of choice, or within a range, set by the parent.

Graphical user interface (GUI) is a type of user interface which allows people to interact with a computer and computer-controlled devices which employ graphical icons, visual indicators or special graphical elements called “widgets”, along with text, labels or text navigation to represent the information and actions available to a user. The actions are usually performed through direct manipulation of the graphical elements.

The remote controller disclosed in the invention facilitates toddlers and preschoolers in operating their home TV without the slightest parental assistance. The proposed remote allows them to independently access their favorite pre-programmed TV channel.

The device and method of the present invention has many technological advantages, among them: simplicity, content control, ergonomic design and full independence, confusion avoiding layout and easy to clean.

Simplicity

The device is adapted to provide the toddler with the ability to independently operate the remote control, and offering equal simplicity for the parent to pre-program the unit with parental control.

Content Control

The device is adapted to enable parental control of the toddler's independent access by means of the adapted remote control, to content predetermined as appropriate and safe.

Additional embodiments are envisaged such that sports dedicated content, news and documentary dedicated content or educationally dedicated content can be selected and exclusively provided.

Customizable Programming enabling the remote to learn the functions of an existing remote control, by entering a code, by downloading the details into the remote by means of a computer web connection, by flashing the internal ROM, or by copying the signal produced by an existing remote.

Ergonomic Design

The remote control offers a unique and attractive design which is ergonomically adapted for toddlers and preschoolers.

Health and Safety Design—The remote control offers a toddler oriented design that addresses specific health and safety concerns that pertain to independent usage by toddlers and preschoolers. It is herein acknowledged that the present invention provides and discloses a remote control conforming to Safety standards for toys such as ASTM standards and ENZ 71 standards relating to toys.

Full Independence

The toddler's and preschooler's remote control provide them with the operational independence they were looking for without requiring parental assistance.

Confusion Avoiding Layout: Buttons are restricted to a minimum, are marked with discernable graphic figures such as content logos, and may be preprogrammed to offer multiple functions in a single depression of a button. It is envisaged that as few as five buttons will be provided, and that these buttons will preferably be labeled with stickers or labels, which may be permanent or in other embodiments, removable. It is a core feature and principle of the invention that there will be an association between the icon or logo on the remote control of their present invention and the icon or logo seen on the screen of the corresponding program or show or TV segment. Such an arrangement is herein defined as icon to icon.

It is further acknowledged that for example, preferred embodiments of the remote control are adapted for customized visual navigation.: In some of these embodiments, the remote is provided with a child proof mask, adapted to be only removable by a parent, with substantially transparent depressions corresponding to the buttons of the remote control. The parent can remove the mask, remove the current program labels from the depressions and replace them with updated labels corresponding to an updated program that the parent has entered into the remote.

It is envisaged that the parentally superintended control unit (PSCU) will further include means for recording the time lapse between multiple depressions of buttons, and more specifically of functions such as ON/OFF and volume control. Further, the parentally superintended control unit (PSCU) is adapted with features to counteract repeated or abrupt actions that are typical to toddler behavior. For example, the parentally superintended control unit will be so adapted that the volume may only be increased to a predetermined level, at a predetermined rate, regardless of how abruptly and extremely the toddler using the device forces the volume control. Rapid and repeated switching on and off of the device or channel changing by the toddler will be rendered harmless in some preferred embodiments by so adapting the PSCU as to time limit the switching on and off of the unit so that it may only be activated a certain number of times in a fixed period.

Additional features and advantages of the invention will become apparent from the following drawing and description.

Reference is now made to an aspect of the present invention which is a remote control unit (SCU) physically comprising;

a. an ergonomically designed enclosure

b. at least one button-operated graphical unit interface (GUI), located on said enclosure;

c. computerized processing means;

d. memory means for storing a plurality of customizable specifications; and,

e. communication means for enabling communication between said control unit and at least one external electronic device;

wherein said unit is configured for allowing a user to control said at least one external electronic device using said GUI only according to said customizable specifications;

and wherein said GUI is configured to display at least one icon or command that is intuitively associated with specific functions of said at least one electronic device

Another object of the present invention is to provide the SCU with a computer web connection and said GUI comprises a virtual interface that electronically displays objects and icons related to specific functions of said at least one electronic device

Another object of the present invention is to provide said SCU adapted for navigation systems such that said user can navigate the web by means selected from the group consisting of global navigation, breadcrumb trails, related links, pagination (previous/next page), footer navigation, text navigation, top-level navigation, persistent navigation and primary navigation

Another object of the present invention is to provide said SCU is adapted for the visual manifestation of navigation systems selected from the group consisting of hyperlinked text, tabs, and buttons

Another object of the present invention is to provide said SCU with widgets

Another object of the present invention is to provide the SCU with means for communicating with web based social networking capabilities

Reference is now made to another aspect of the present invention which is the SCU adapted to provide TV or web content from TV content lists or TV guides provided on said GUI by single click or touch screen of program selections from said lists or guides.

Reference is now made to another aspect of the present invention which is the SCU wherein at least one of the following holds true
THe GUI has at least one said object and icon with an CIE L*a*b* characterised by an L value of between 0 and 100, an *a value of between −100 and +100 and b* value of between −100 and +100,
a resolution of between 0.1 mm to 5 mm. in the electromagnetic range of between 300 nm and 700 nm,
a contrast ratio of between 1/2 and 1/10,000 in the electromagnetic range of between 300 nm and 700 nm.

Reference is now made to another aspect of the present invention which is the SCU wherein at least one of the following is true;

said at least one icon is selected from a group consisting of icons, trademarks, logos, symbols, characteristic color or color mixture, shape, including 3D and 2D shaped icons, textured icons or a combination thereof

said external device is a television.

said customizable specifications includes specific television channels or programs which the user is permitted to watch,

said SCU is provided with secondary processing means conventionally used in cable and satellite boxes, further wherein said secondary memory means may be used to download frequencies and thereby select permitted channels and programs.

said secondary processing means is selected from a group consisting of smart cards, SIM cards or microchips.

Reference is now made to another aspect of the present invention which is the SCU physically engineered and electronically adapted for use by any persons selected from the group consisting of of elderly users, partially sighted users, hearing impaired users, disabled users, mentally impaired users, child users, users who are toddlers, teenage users, attention deficit disorder users, or adult users or any combination thereof

Reference is now made to another aspect of the present invention which is the SCU in which said electronic device is selected from a group including television, video players, DVD players, stereo players, audio players, computers, smartphones, or any combination thereof

Reference is now made to another aspect of the present invention which is the SCU in which said customizable specifications includes volume, channel switching, forbidden content, or any combination thereof.

Reference is now made to another aspect of the present invention which is the SCU in which said control unit further comprises a means for recording the time lapse between multiple depressions of buttons, and more specifically of functions such as ON/OFF and volume control, and is configured to ignore the repeated actions that are typical to toddler behavior or aberrant behavior

Reference is now made to another aspect of the present invention which is the SCU wherein at least one of the following holds true

said interface is configured for allowing the user to update said customizable specifications as desired

said interface operates by allowing the user to flash the ROM of said unit.

said interface is configured for allowing a parent or supervisor to alter the operating parameters of at least one function of said unit.

Reference is now made to another aspect of the present invention which is the SCU configured for allowing an individual to change said at least one function of said unit whilst using a computer, television, wireless device, or other device connected to said unit wherein said individual is selected from the group consisting of parent, supervisor,child or toddler.

Reference is now made to another aspect of the present invention which is the SCU wherein at least oner of the following holds true
said external device is a television, and wherein said unit is configured for allowing a toddler to begin viewing said television, in a specific predetermined condition.
wherein at least one button of said GUI, is physically labeled with a sticker that displays objects or icons related to the desired content.

Reference is now made to another aspect of the present invention which is the SCU wherein said GUI, comprises a virtual interface that electronically displays objects, icons or buttons related to said desired content.

Reference is now made to another aspect of the present invention which is the SCU wherein at least one of the following holds true:

said GUI includes buttons that are color coded according to groups of desired content.

said GUI includes buttons that incorporate electronic displays showing objects or icons relating to the desired content.

said GUI includes touch screen that incorporates electronic displays showing objects or icons relating to the desired content.

said objects or icons represent one or more channels, options, parameters or any combination thereof.

Reference is now made to another aspect of the present invention which is the SCU

Reference is now made to another aspect of the present invention which is the SCU wherein at least one of the following is true, said SCU is configured for accepting secondary processing means connected to a cable and satellite box, said secondary memory means are selected from the group consisting of Smart Cards, SIM cards, and microchips said secondary memory means can be programmed by said control unit in order to enhance communication between said unit and said cable or satellite box

said communication is wireless

a front panel of the unit can be customized to personal color preference or for commercial purposes.

the SCU is configured for sport programs

the SCU is configured for news programs.

said SCU is configured for displaying icons or logos that are visually associated with the icon or logo seen on the screen of the corresponding programme, show or TV segment.

said ergonomically designed enclosure is adapted for a user who is a toddler

said enclosure is elliptically shaped in order to enhance identification of buttons by the toddler or wherein the back of said unit is scored in order to avoid slippage when placed on varied surfaces.

Reference is now made to another aspect of the present invention disclosing a method for using a remote control unit (SCU) physically engineered and electronically adapted to the operating requirements of, any persons selected from the group consisting of elderly users, partially sighted users, hearing impaired users, disabled users, mentally impaired users, child users, users who are toddlers, teenage users, attention deficit disorder users, or adult users or any combination thereof which can be used for selecting and viewing TV and web content comprising steps of;

a. obtaining said remote control unit (SCU) comprising;

an ergonomically designed enclosure

at least one button-operated graphical unit interface (GUI), located on said enclosure;

computerized processing means;

memory means for storing a plurality of customizable specifications; and, communication means for enabling communication between said control unit and at least one external electronic device;

wherein said unit is configured for allowing a user to control said at least one external electronic device using said GUI only according to said customizable specifications;

and wherein said GUI is configured to display at least one icon or command that is intuitively associated with specific functions of said at least one electronic device and said SCU is provided with a computer web connection further wherein said GUI comprises a virtual interface that electronically displays objects and icons related to specific functions of said at least one electronic device, further wherein said device is adapted to provide TV programs and content or web content from TV content lists or TV guides provided on said GUI by single click or touch screen of program selections from said lists or guides and

b. operating said touch screen to view said TV or programs and content or web content.

Reference is now made to a parentally superintended remote control unit (SCU) physically engineered and electronically adapted to the special operating requirements of toddlers and preschoolers The SCU comprises at least one enclosure ergonomically designed to fit the hands and digits of the toddler, at least one toddler oriented button operated graphical unit interface (GUI), offering access to at least one electronic device function; at least one computerized processing means; at least one memory means adapted to store parentally customizable specifications; and, at least one communication means adapted to enable communication between the control unit and an electronic device preferably a TV. The SCU is provided with means to select T.V. channels and programs from a predetermined parentally approved list; and the GUI displays and commands at least one icon intuitively associated with the desired content.

Reference is now made to an SCU as described above, wherein the intuitively associated icon is selected from a group consisting of icons, trademarks, logos, symbols, characteristic color or color mixture, shape, including 3D and 2D shaped icons, textured icons or a combination thereof.

Reference is now made to a parentally superintended remote control unit (SCU) as physically engineered and electronically adapted to the special operating requirements of toddlers and preschoolers, comprising at least one enclosure ergonomically designed to fit the hands and digits of a toddler, fashioned without sharp edges and fastened tightly together; at least one toddler oriented button operated graphical unit interface (GUI), offering access to at least one device function; at least one computerized processing means; at least one memory means adapted to store said user customizable specifications; and, at least one communication means adapted to enable communication between the control unit and an electronic device preferably a TV, wherein the SCU is provided with smart cards, SIM cards or microchips conventionally used in cable and satellite boxes, further wherein the smart cards, SIM cards or microchips may be used to download frequencies and thereby select parentally permitted channels and programs.

Reference is now made to an exemplary FIG. 1 illustrating a particular embodiment of the present invention which is a toddler oriented, egonomically shaped remote control 10, is fitted with an ON/OFF button 12, five preprogrammed buttons 14, inset with miniscule lcd screens that depict logos of selected TV channels, and volume control button 16. It is herein emphasized that FIG. 1. is merely exemplary and many other embodiments will occur to a person skilled in the art, especially many embodiments suitable for use by any persons selected from the group consisting of of elderly users, partially sighted users, hearing impaired users, disabled users, mentally impaired users, child users, users who are toddlers, teenage users, attention deficit disorder users, or adult users or any combination thereof

Reference is now made to a control unit physically engineered and electronically adapted to the special requirements of toddlers, preschoolers, and the cognitively challenged. The control unit comprises at least one enclosure ergonomically designed to fit the hands and digits of a toddler, made of a minimal amount of parts fashioned without sharp edges, and fastened tightly together; at least one toddler oriented interface, offering access to at least one appliance function; at least one parent oriented interface, offering parental restriction of selected parameters and content accessed by said toddler oriented interface; at least one computerized processing means; at least one memory means adapted to store said user customizable specifications; and, at least one communication means adapted to enable communication between said control unit and an electronic device.

Reference is now made to another embodiment of the invention wherein parentally superintended control of the toddler controlled unit is achieved through a proprietary sequence of inputs or a code.

Reference is now made to another embodiment of the invention described above, wherein the enclosure is sealed with hidden screws.

Reference is now made to another embodiment of the invention described above wherein the enclosure is sealed by plastic soldering.

Reference is now made to another embodiment of the invention described above wherein the enclosure is sealed by pressure.

Reference is now made to another embodiment of the invention described above wherein the enclosure is liquid resistant.

Reference is now made to another embodiment of the invention described above wherein the enclosure and the toddler interface is constructed of non toxic materials.

Reference is now made to another embodiment of the invention described above wherein the enclosure can withstand considerable physical abuse.

Reference is now made to another embodiment of the invention wherein the control unit is a remote control.

Reference is now made to another embodiment of the invention wherein the electronic device is selected from a group including television, video players, DVD players, stereo players, audio players, ovens, refrigerators, computers, peripherals, or any combination thereof.

Reference is now made to another embodiment of the invention wherein the parameter controlled can be, inter alia, volume, channel switching, content recording, forbidden content, or any combination thereof.

Reference is now made to another embodiment of the invention described above further comprising a means for recording the time lapse between multiple depressions of buttons, and more specifically of functions such as ON/OFF and volume control, adapted to counteract repeated actions that are typical to toddler behavior.

Reference is now made to another embodiment of the invention wherein the control unit further comprises one or more interfaces adapted to facilitate the user in updating and altering said parameters in said unit.

Reference is now made to another embodiment of the invention described above wherein the updating means is based on flashing the ROM of the unit.

Reference is now made to another embodiment of the invention wherein the control unit, further comprises an interface adapted to facilitate the parent in updating and altering the parameters.

Reference is now made to another embodiment of the invention wherein the update can be done using a computer, the television, wireless device, or other device connected to the control unit.

Reference is now made to another embodiment of the invention wherein the user is enabled to start using the electronic device in a specific condition.

Reference is now made to another embodiment of the invention wherein the television is automatically turned on at desired channel and/or a desired volume, and automatically turns off at a specific hour.

Reference is now made to another embodiment of the invention wherein a virtual interface is provided that electronically displays objects and icons related to the desired content.

Reference is now made to another embodiment of the invention wherein the control unit further comprises a physical button interface, wherein each button incorporates an electronic display that displays objects or icons related with the desired content.

Reference is now made to another embodiment of the invention wherein the control unit further comprises a physical button interface, wherein each button is physically labeled with a sticker that displays objects or icons related to the desired content.

Reference is now made to another embodiment of the invention wherein the control unit further comprises a physical button interface, wherein each button is physically labeled with a parent removable sticker that displays objects or icons related to the desired content.

Reference is now made to another embodiment of the invention wherein the icons represent one or more channels, options, parameters or any combination thereof.

Reference is now made to another embodiment of the invention wherein the control unit is elliptically shaped in order to enhance identification of buttons by the toddler.

Reference is now made to another embodiment of the invention wherein the back of the unit is scored in order to avoid slippage when placed on varied surfaces.

Reference is now made to another embodiment of the invention wherein the unit is adapted to accept smart cards, SIM cards or microchips conventionally used in cable and satellite boxes wherein the aforementioned smart cards, SIM cards or microchips may be used to download frequencies of parental permitted channels and programs.

Reference is now made to another embodiment of the invention wherein the unit is adapted to accept smart cards, SIM cards or microchips conventionally used in cable and satellite boxes wherein the aforementioned smart cards, SIM cards or microchips may be used to download frequencies of subscription permitted channels and programs.

Reference is now made to another embodiment of the invention wherein the smartcard can be programmed by said control unit in order to enhance communication between said controller and said cable or satellite box.

Reference is now made to another embodiment of the invention wherein the front panel of the unit can be replaced and customized to personal color preference or for commercial purposes.

Reference is now made to another embodiment of the invention wherein the control unit is adapted for controlling sport programs.

Reference is now made to another embodiment of the invention wherein the control unit is adapted for controlling news programs.

Further, reference is now made to another embodiment of the invention wherein a method is disclosed for regulating the operation of one or more electronic devices using a control unit. The method comprises inputting commands concerning the volume and/or On/Off commands; checking whether the number of consecutive commands is inputted at a higher rate than a predetermined level and sending the command to the electronic device if the checking step is satisfied.

Reference is now made to a method for parentally superintending TV channel choice to toddlers and preschoolers by providing a remote control unit (SCU) physically engineered and electronically adapted to the special operating requirements of toddlers and preschoolers. The method comprises steps of; obtaining the aforementioned SCU and adapting the SCU such that the choice of channels and programs accessed by said SCU is predetermined by parents. The method further comprises a step of adapting the SCU such that at least one enclosure is ergonomically designed to fit the hands and digits of a toddler, fashioned without sharp edges and fastened tightly together and the toddler is provided with at least one toddler oriented button operated graphical unit interface (GUI), offering access to at least one electronic device function. At least one computerized processing means is also provided and so is at least one memory means adapted to store said parentally customizable specifications. Communication means are provided enabling communication between the parentally superintended SCU and an electronic device preferably a TV.

A method for parentally superintending TV channel choice to toddlers and preschoolers is disclosed. The method for providing a remote control unit (SCU) physically engineered and electronically adapted to the special operating requirements of toddlers and preschoolers, comprises steps of; obtaining SCU adapting the SCU such that the choice of channels and programs accessed by the SCU is predetermined by parents further adapting the SCU such that at least one enclosure is ergonomically designed to fit the hands and digits of a toddler, fashioned without sharp edges and fastened tightly together; providing at least one toddler oriented button operated graphical unit interface (GUI), offering access to at least one electronic device function; providing at least one computerized processing means; further providing at least one memory means adapted to store said parentally customizable specifications; and, providing at least one communication means adapted to enable communication between the control unit and an electronic device, which is preferably a TV. The method further comprises providing SCU with means to select T.V. channels and programs from a predetermined parentally approved list; and the method further comprises providing at least one GUI display, the display commanding at least one icon intuitively associated with the desired content.

Additionally, reference is now made to another embodiment of the invention wherein the method is especially adapted to television, video, DVD, audio player, or any combination thereof

Moreover, reference is now made to another embodiment of the invention wherein the above mentioned method comprises an additional step of limiting the access of the users only to predetermined channels.

Yet further reference is now made to another embodiment of the invention wherein the method further comprises an additional step of pressing a button with adaptive icon which represents content in a specific channel, and automatically displaying the aforementioned channel.

Lastly, reference is now made to another embodiment of the invention wherein the method further comprises an additional step of updating the meaning of one or more parameters or icons in said unit.

1. A remote control unit (SCU) physically comprising;
a. an ergonomically designed enclosure
b. at least one button-operated graphical unit interface (GUI), located on said enclosure;
c. computerized processing means;
d. memory means for storing a plurality of customizable specifications; and,
e. communication means for enabling communication between said control unit and at least one external electronic device;
wherein said unit is configured for allowing a user to control said at least one external electronic device using said GUI only according to said customizable specifications;
and wherein said GUI is configured to display at least one icon or command that is intuitively associated with specific functions of said at least one electronic device

2. The SCU according to claim 1 wherein said SCU is provided with a computer web connection and said GUI comprises a virtual interface that electronically displays objects and icons related to specific functions of said at least one electronic device

3. The SCU according to claim 2 wherein said SCU is adapted for navigation systems such that said user can navigate the web by means selected from the group consisting of global navigation, breadcrumb trails, related links, pagination (previous/next page), footer navigation, text navigation, top-level navigation, persistent navigation and primary navigation

4. The SCU according to claim 2 wherein said SCU is adapted for the visual manifestation of navigation systems selected from the group consisting of hyperlinked text, tabs, and buttons

5. The SCU according to claim 2 wherein said SCU is provided with widgets

6. The SCU according to claim 2 wherein said SCU is provided with means for communicating with web based social networking capabilities

7. The SCU according to claim 2 wherein said device is adapted to provide TV or web content from TV content lists or TV guides provided on said GUI by single click or touch screen of program selections from said lists or guides.

8. The SCU according to claim 2 wherein at least one of the following holds true

9. The SCU according to claim 2 wherein at least one of the following is true,
at least one said object and icon has an CIE L*a*b* characterised by an L value of between 0 and 100, an *a value of between −100 and +100 and b* value of between −100 and +100,
a resolution of between 0.1 mm to 5 mm. in the electromagnetic range of between 300 nm and 700 nm,
a contrast ratio of between 1/2 and 1/10,000 in the electromagnetic range of between 300 nm and 700 nm.

10. The SCU according to claim 1, wherein at least one of the following is true;
said at least one icon is selected from a group consisting of icons, trademarks, logos, symbols, characteristic color or color mixture, shape, including 3D and 2D shaped icons, textured icons or a combination thereof
said external device is a television.
said customizable specifications includes specific television channels or programs which the user is permitted to watch.
said SCU is provided with secondary processing means conventionally used in cable and satellite boxes, further wherein said secondary memory means may be used to download frequencies and thereby select permitted channels and programs.
said secondary processing means is selected from a group consisting of smart cards, SIM cards or microchips.

11. The SCU according to claim 1, in which said SCU is physically engineered and electronically adapted to any persons selected from the group consisting of of elderly users, partially sighted users, hearing impaired users, disabled users, mentally impaired users, child users, users who are toddlers, teenage users, attention deficit disorder users, or adult users or any combination thereof

12. The SCU according to claim 1, in which said electronic device is selected from a group including television, video players, DVD players, stereo players, audio players, computers, smartphones, or any combination thereof.

11. The SCU according to claim 1, in which said customizable specifications includes volume, channel switching, forbidden content, or any combination thereof.

12. The SCU according to claim 1, in which said control unit further comprises a means for recording the time lapse between multiple depressions of buttons, and more specifically of functions such as ON/OFF and volume control, and is configured to ignore the repeated actions that are typical to toddler behavior or aberrant behavior

13. The SCU according to claim 1, wherein at least one of the following holds true
said interface is configured for allowing the user to update said customizable specifications as desired
said interface operates by allowing the user to flash the ROM of said unit.
said interface is configured for allowing a parent or supervisor to alter the operating parameters of at least one function of said unit.

14. The SCU according to claim 1, configured for allowing an individual to change said at least one function of said unit whilst using a computer, television, wireless device, or other device connected to said unit wherein said individual is selected from the group consisting of parent, supervisor, child or toddler.

15. The SCU according to claim 1, wherein at least oner of the following holds true
said external device is a television, and wherein said unit is configured for allowing a toddler to begin viewing said television, in a specific predetermined condition.
wherein at least one button of said GUI, is physically labeled with a sticker that displays objects or icons related to the desired content.

16. The SCU according to claim 1, wherein said GUI, comprises a virtual interface that electronically displays objects, icons or buttons related to said desired content.

20. The SCU according to claim 1, wherein at least one of the following holds true
said GUI includes buttons that are color coded according to groups of desired content.
said GUI includes buttons that incorporate electronic displays showing objects or icons relating to the desired content.
said GUI includes touch screen that incorporates electronic displays showing objects or icons relating to the desired content.
said objects or icons represent one or more channels, options, parameters or any combination thereof.

21. The SCU according to claim 1, wherein at least one of the following is true, said SCU is configured for accepting secondary processing means connected to a cable and satellite box,
said secondary memory means are selected from the group consisting of Smart Cards, SIM cards, and microchips said secondary memory means can be programmed by said control unit in order to enhance communication between said unit and said cable or satellite box
said communication is wireless
a front panel of the unit can be customized to personal color preference or for commercial purposes.
the SCU is configured for sport programs
the SCU is configured for news programs.
said SCU is configured for displaying icons or logos that are visually associated with the icon or logo seen on the screen of the corresponding programme, show or TV segment.
said ergonomically designed enclosure is adapted for a user who is a toddler
said enclosure is elliptically shaped in order to enhance identification of buttons by the toddler or wherein the back of said unit is scored in order to avoid slippage when placed on varied surfaces.

22. A method for providing a remote control unit (SCU) physically engineered and electronically adapted to the operating requirements of, any persons selected from the group consisting of elderly users, partially sighted users, hearing impaired users, disabled users, mentally impaired users, child users, users who are toddlers, teenage users, attention deficit disorder users, or adult users or any combination thereof
comprising steps of;
a. obtaining said remote control unit (SCU) comprising;
an ergonomically designed enclosure
at least one button-operated graphical unit interface (GUI), located on said enclosure;
computerized processing means;
memory means for storing a plurality of customizable specifications; and, communication means for enabling communication between said control unit and at least one external electronic device;
wherein said unit is configured for allowing a user to control said at least one external electronic device using said GUI only according to said customizable specifications;
and wherein said GUI is configured to display at least one icon or command that is intuitively associated with specific functions of said at least one electronic device and said SCU is provided with a computer web connection further wherein said GUI comprises a virtual interface that electronically displays objects and icons related to specific functions of said at least one electronic device, further wherein said device is adapted to provide TV programs and content or web content from TV content lists or TV guides provided on said GUI by single click or touch screen of program selections from said lists or guides and
b. operating said touch screen to view said TV or programs and content or web content.
